(19) United States
(12) Patent Application Publication
(10) Pub. No.: US 2018/0365629 A1
(43) Pub. Date: Dec. 20, 2018

(54) TAXI-BASED EXPRESS PACKAGE DELIVERY METHOD, SYSTEM AND SERVER

(71) Applicant: Zhaoxing ZENG, Guangzhou (CN)

(72) Inventors: Zhaoxing ZENG, Guangzhou (CN); Xuecong LI, Guangzhou (CN)

(21) Appl. No.: 16/116,906

(22) Filed: Aug. 30, 2018

Related U.S. Application Data
(63) Continuation of application No. PCT/CN2016/094095, filed on Aug. 9, 2016.

(30) Foreign Application Priority Data
Apr. 13, 2016 (CN) 201610227902.8

(51) Int. Cl. G06Q 10/08; G08G 1/00; G01C 21/34; G06Q 30/02; G06Q 50/30

(52) U.S. Cl. CPC G06Q 10/083; G08G 1/202; G06Q 50/30; G01C 21/343; G06Q 30/0207; G01C 21/3438

(57) ABSTRACT

A taxi-based delivery method, system and server using the same, comprising acquiring a first start point and a first terminal point of an express package; acquiring a second start point and a second terminal point of each of a plurality of taxis that carry passengers and generating a plurality of riding paths; if the first start point is within a first preset distance from the riding paths and the first terminal point is within a second preset distance from the riding paths, listing the taxi as a delivery-capable taxi and notifying it to deliver the express package. According to the start point, the terminal point and arrival time of the express package, it is ensured that the express package can be arrived on time. The passengers taking the ride can get the discount on the ride through such a carpooling method.

### CROSS-REFERENCE TO RELATED APPLICATIONS

This application is a continuation of International Application No. PCT/CN2016/094095 with a filing date of Aug. 9, 2016, designating the United States, now pending, and further claims to Chinese application No. 201610227902.8 with a filing date of Apr. 13, 2016. The content of the aforementioned applications, including any intervening amendments thereto, are incorporated herein by reference.

### FIELD OF THE INVENTION

The present invention relates to the field of urban transportation and, in particular, to a carpool-based package delivery method, system, and server.

### BACKGROUND OF THE INVENTION

Taxis are an important part of traffic of cities. At present, the total number of taxis in China has reached more than 1.1 million and the annual passenger volume reaches 12 billion trips, producing imaginable energy consumption. Moreover, at present, most taxis can carry passengers from only one place, and in most cases, only one passenger, resulting in a great waste of resources. On the other hand, with the rapid development of online shopping, the express service industry has also seen explosive growth in recent years. No matter for individuals or companies, more goods are delivered by express.

In existing package delivery methods, it usually takes 6 hours or even 24 hours to complete the delivery of packages within a same city or from adjacent cities due to the package quantity and the logistics arrangement. In more urgent cases, a sender can only take goods directly to a designated destination by taxi. At the time of delivery, a courier needs to notify a user of the arrival of a package before delivery. In this process, there are disadvantages such as that the user is not at home and cannot take the package or is in a hurry and cannot wait for the courier to arrive. Separately sending a taxi to deliver a package costs relatively much higher.

In addition, in existing logistics delivery processes, a package needs to be delivered by a courier and a recipient in person, but the recipient may not be at a delivery address when the courier delivers the package and cannot sign the package in person. Moreover, restricted by factors such as working hours and areas in charge of couriers, the delivery efficiency and the delivery success rate are low, and imperfect links and procedures not only have greatly aggravated the workload of the logistics industry, but also cause great inconvenience to recipients.

### SUMMARY OF THE INVENTION

### Technical Solution

Based on the above situation, the present disclosure proposes a taxi-based express package delivery method. In the same city, since express package delivery is done within a certain period of time and a certain regional extent. By carrying the express package from the start point to the terminal point via a taxi, delivery of emergency express package in the same city can be realized. By using the start point and the terminal point of the express package delivery to select the taxis that already carry passengers within the regional extent, it is possible to effectively optimize the use of the taxis. On the one hand, the delivery issue of express package within a certain period of time can be solved; on the other hand, cost of personal transportation of the passenger can be shared.

The present disclosure discloses a taxi-based express package delivery method, including the steps of: acquiring a first start point and a first terminal point of the express package; acquiring a second start point and a second terminal point of each of a plurality of taxis that carry passengers and generating a plurality of riding paths; listing the taxi as a delivery-capable taxi, if the first start point is within a first preset distance from the riding paths and the first terminal point is within a second preset distance from the riding paths;

acquiring a first time point when the express package arrives at the first terminal point; calculating a second time point when the delivery-capable taxi arrives at the first terminal point from the current position, and acquiring the second time point when the delivery-capable taxi arrives at the first terminal point; removing the corresponding delivery-capable taxi from the delivery-capable taxis if the second time point when the delivery-capable taxi arrives at the first terminal point is later than the first time point when the express package arrives at the first terminal point;

notifying the delivery-capable taxi of which the second time point is earlier than the first time point to deliver the express package among the delivery-capable taxis.

Further, the method includes acquiring a third time point when the passenger requests to reach the second terminal point; calculating a fourth time point when the delivery-capable taxi arrives at the second terminal point from the current position; acquiring the fourth time point when the delivery-capable taxi arrives at the second terminal point; removing the corresponding delivery-capable taxi from the delivery-capable taxi, if the fourth time point when the delivery-capable taxi arrives at the second terminal point is later than the fourth time point when the express package arrives at the second terminal point.

A delivery path is acquired according to the first start point and the first terminal point. A riding path is acquired according to the second start point and the second terminal point of the passenger. The delivery path is consistent with the riding path.

A latest departure time of the express package is acquired according to the first start point, the first terminal point and arrival time of the express package. If there is no delivery-capable taxi available in the preset time range of the latest departure time, a taxi is called using the first start point and the first terminal point.

After the express package is delivered to the first terminal point, an address of a first user within a residential community is acquired. Addresses of second users corresponding to all the express packages are acquired; the express packages of which the second users' addresses are within a preset distance from the first user are screened out and delivered by the first user.

The present disclosure also discloses a taxi-based express package delivery system, including an express package delivery client, a server, and passenger clients. The express package delivery client is configured to acquire a first start point and a first terminal point of the express package. The passenger clients are configured to acquire a second start point and a second terminal point of each of a plurality of taxis that carry passenger. And the server is configured to receive the first start point and the first terminal point of the express package delivery client and the second start point and the second terminal point of each of the passenger clients and to generates a plurality of riding paths according to the second start points and the second terminal points. If the first start point is within a first preset distance of the riding path and the first terminal point is within a second preset distance of the riding path, the taxi that carries the passenger is listed as a delivery-capable taxi.

The express package delivery system further includes a taxi calling module, configured to acquire a delivery arrival time, to calculate a time of the delivery-capable taxi from the current location to the first terminal point, and to acquire an arrival time of the delivery-capable taxi. If The arrival time of the taxi is later than the express package arrival time, the corresponding taxi is removed from the delivery-capable taxi. The delivery-capable taxi is notified to deliver the express.

Further, a taxi-based express package delivery server is disclosed, wherein the server is configured to acquire a first start point and a first terminal point of the express package, to acquire a second start point and a second terminal point of each of a plurality of taxis that carry passengers and generating a plurality of riding paths. If the first start point is within a first preset distance from the riding paths and the first terminal point is within a second preset distance from the riding paths, the taxi is listed as a delivery-capable taxi. The taxi calling module is configured to acquire a first time point when the express package arrives at a first terminal point, to calculate a second time point when the delivery-capable taxi arrives at the first terminal point from the current position, and to acquire the second time point when the delivery-capable taxi arrives at the first terminal point. If the second time point when the delivery-capable taxi arrives at the first terminal point is later than the first time point when the express package arrives at the first terminal point, the corresponding delivery-capable taxi is removed from the delivery-capable taxis. And the delivery-capable taxi of which the second time point is earlier than the first time point notified to deliver the express package.

### Advantageous Effects of the Present Disclosure

### Beneficial Effects

Compared with the prior art, the present disclosure is simple in operation, and according to the start point, the terminal point and the arrival time of the express package, neighboring taxis carrying passengers are screened out at the beginning. In this way, it is ensured that the express package can be arrived on time, at the same time, the passengers taking the ride can get the discount on the ride through such a carpooling method.

### BRIEF DESCRIPTION OF THE DRAWINGS

FIG. 1 is a schematic flow chart of a taxi-based express package delivery method according to the present disclosure;

FIG. 2 is a schematic structural view of an embodiment of a taxi-based express package delivery system according to the present disclosure.

### DETAILED DESCRIPTION OF ILLUSTRATED EMBODIMENTS

The solution of the present disclosure will be described in detail below in conjunction with preferred embodiments thereof.

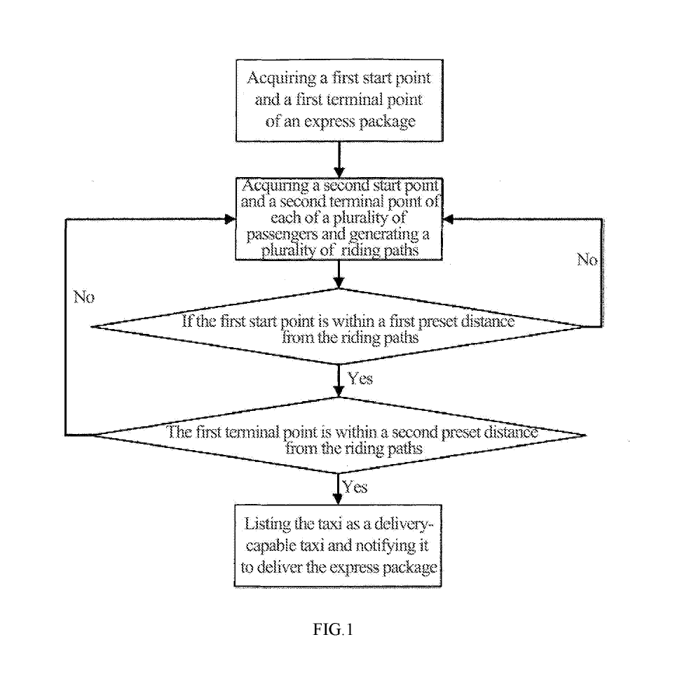

As shown in FIG. 1, the method of this embodiment includes the following steps:

S101: acquiring a first start point and a first terminal point of the express package.

For express package deliveries in the same city or between adjacent cities, it usually takes 6 hours to 12 hours. Some urgent express packages (such as those must be delivered within two to three hours) are difficult for normal express package delivery companies to handle. The only way to handle such packages is for a personnel to take a taxi to the terminal point, bring the packages to the designated persons and then take the taxi back to the start point, which wastes manpower and increases the cost of taxi ride.

By acquiring the first start point and the first terminal point of the express package and calling a neighboring taxi, the express package can be sent from the start point to the terminal point. However, in this case, each taxi call is costly. At the same time, if there are many express packages around, they can be sent together.

S102: acquiring a second start point and a second terminal point of each of a plurality of taxis that carry passengers and generating a plurality of riding paths.

Within the latest arrival time allowed by the express package, information of a plurality of neighbouring taxis that already carry passengers is collected continuously, and a plurality of riding paths are generated according to the second start point and the second terminal point of the plurality of taxis that carry passengers.

The passenger gets on the taxi at location 0 (the second start point is known by default) and informs the taxi driver of the second terminal point. At this time, the information of the start point and the terminal point of the passenger can be uploaded to the server through the passenger client mobile phone or the taxi driver mobile phone or other communication terminal. The mobile phones are smart phones, and the smart phones and the communication terminal are all provided with a positioning module. The positioning module includes but not limited to GPS satellite positioning, Beidou satellite positioning and assisted positioning through base stations and WIFI. The smart phones and the communication terminal are equipped with APP software. The smart phones and the communication terminal use the APP software to transmit information such as location to the server through the wireless network. The server acquires the contents of the database and generates a riding path based on experience value. As a more preferred example, the server also takes into account the current congestion condition of the road when generating the riding path. Generally speaking, passengers will consider various factors when taking a taxi, among which, time factor and price factor are the main considerations. In this embodiment, the time factor is mainly considered. The method of generating the riding path comprises determining a start point and a terminal point of a first passenger, selecting first M riding paths from the start point to the terminal point, dividing each riding path in the M riding paths into a plurality of small segmented paths, respectively calculating average speed of the taxi passing each small segmented path, then calculating according to the length of each small segmented path the average time it takes to pass each small segmented path, and adding the average time of each small segmented path to get the total riding time of each riding path, comparing the riding time of each riding path and taking the riding path with the shortest riding time as the fastest riding path (i.e. selected as the first riding path).

After acquiring the first start point and the first terminal point of the express package, the server continuously receives a second start point and a second terminal point of each of neighbouring N passengers, and generates N corresponding riding paths based on this information. Since the taxi will generate different combinations of express packages and passengers according to the actual situation after driving, for different combinations of express packages and passengers, the shorter the path distance of the driver to pick up the passengers is, the lower the cost is, thereby improving utilization of taxi resources. Therefore, it is more important to select the best carpooling combination among a plurality of combinations of express packages and passengers. In addition, the delivery path and the riding path are preset paths stored in the database, and are the empirical data that can be retrieved from the database of the server after the passenger inputs the information of the start point and the terminal point. The influences of the environmental factors are generally not considered. Otherwise, the fastest riding path can also be used.

In order to ensure the effectiveness of the combination of express package and passenger, it is necessary to know in advance whether the delivery path of the express package is in line with and the riding path of the passenger. Therefore, it is necessary to first acquire the delivery path through the first start point and the first terminal point; and then the riding path according to the second start point and the second terminal point of the passenger is acquired; and the delivery path is ensured to be consistent with the riding path.

S103: if the first start point is within a first preset distance from the riding paths and the first terminal point is within a second preset distance from the riding paths, the taxi is listed as a delivery-capable taxi; and the delivery-capable taxi which has the second time point earlier than the first time point is notified to deliver the express package among the delivery-capable taxis.

Although deliveries of express packages are done based on taxis that carry passengers, which saves the express package delivery fee and the passenger's taxi fee, it is also necessary to meet the express package arrival time and the passenger arrival time. Therefore, it is necessary to acquire the third time point for the passenger to reach the second terminal point, to calculate a fourth time point when the delivery-capable taxi arrives the second terminal point from the current position and to acquire the fourth time point when the delivery-capable taxi arrives at the second terminal point. If the fourth time point that the delivery-capable taxi arrives at the second terminal point is later than the fourth time point when the express package arrives at the second terminal point, the delivery-capable taxi removed from the delivery-capable taxis.

After the taxi-based express package delivery system rejects the delivery-capable taxi that does not meet the above conditions, the taxi-based express package delivery system notifies the remaining delivery-capable taxis that meet the above conditions to deliver the express package, and finally selects one delivery-capable taxi in the following manners according to the actual demand.

1. The express package delivery client actively selects a delivery-capable taxi to deliver the express package.

2. The passenger on the delivery-capable taxi can accept the order to deliver the express package through the passenger client or the driver through the mobile phone, the communication terminal and the calling module.

3. The taxi-based delivery system chooses to notify the delivery-capable taxi of which the second time point is earlier than the earliest time value of the first time point to deliver the express package, or to notify the delivery-capable taxi of which the first start point is at the shortest distance from the second start point to deliver the express package, or to notify the delivery-capable taxi of which the first terminal point is at the shortest distance from the second terminal point to deliver the express package.

If one of the above selections is refused by one of the parties, then the selection has to be made for another round. If it is in a peak period or if no party is willing to take orders due to long distance, the express package delivery fee may be increased to encourage passengers or taxi drivers to take orders.

In real conditions, the situation of carpooling of express package and passenger is complicated. With the popularity of carpooling software, carpooling of express package and passenger becomes possible. Within the latest arrival time allowed by the express package, for example, if the express package start point is sent at 8 o'clock in the morning, and it is required to be delivered to the terminal point within 2 hours, and it takes only 30 minutes for the taxi to arrive at the terminal point from the start point, during this time, the taxi can pick up the passengers around, as long as the express package can be delivered on time. Therefore, through the start and terminal points of the express package delivery, the taxis carrying passengers around are sorted out at the beginning, so that the express package can be reached at the terminal point on time, and the passengers can get a discount for the ride through such carpooling.

The combination of express package and passenger needs to satisfy the requirements that the express package can be delivered on time and the passenger can arrive at the terminal point in time.

Therefore, a first time point when the express package arrives is acquired. A second time point is calculatedvwhen the delivery-capable taxi arrives at the first terminal point of the express package from the current position. The second time point when the delivery-capable taxi arrives (i.e. the time point when the taxi arrives at the terminal point) is acquired. If the second time point when the delivery-capable taxi arrives at the first terminal point is later than the first time point when the express package arrives at the first terminal point, the corresponding delivery-capable taxi is removed from the delivery-capable taxis. Through such a removing method, although the express package delivery can be guaranteed to arrive on time, it directly leads to the possibility that no taxi meet the requirements. At this time, the fastest arrival time of the express package from the first start point to the first terminal point is roughly calculated, and then the latest departure time is obtained by the express package arrival time subtracting the fastest arrival time. When no carpooling of express package and passenger is formed when it is close to the latest departure time (such as 1-10 minutes in advance), a taxi is directly called according to the first start point and the first terminal point. The latest departure time of the express package is obtained through the first start point, the first terminal point and the express package arrival time. If there is no delivery-capable taxi in the preset time range of the latest departure time (generally 1-20 minutes in advance), a taxi is directly called according to the first start point and the first terminal point. The taxi that is called at this time is a non-carpooling taxi, and the cost is comparably higher.

In fact, for two places that appear to be very close on the satellite map, the taxi may need to ride a long distance to arrive in actually driving. Therefore, the carpooling reminder should be able to be canceled according to the actual situation. The specific implementation steps are: generating a second riding path according to the first start point and the second terminal point of the express package and the second start point and the second terminal point of the passenger. If the distance between the second riding path and the riding path is greater than a preset path length, the delivery-capable taxi is removed from the delivery-capable taxis. The preset path length here is an experience value, and can be set by the first passenger or driver according to actual situation.

In addition, there may be a second passenger on the way, and then the carpooling can also be performed at this time. The specific steps are: acquiring a start point and an terminal point of the second passenger, and if the distance between the start point of the second passenger and the riding path is within a first preset distance and the distance between the terminal point of the second passenger and the riding path is within a second preset distance, issuing a carpooling reminder to the second passenger.

At present, express package delivery and collection are problematic for many users. The main problems are as follows. 1. Express packages usually are delivered at working hours (9 am to 18 pm), and the users are always in the office but not at home. 2. In some residential communities, security control is relatively restrict, and users generally have to go downstairs to collect the express packages. Concerning the above problems, the present disclosure proposes that, for the express package delivery of users in the same community, residents of the community, through registration, may offer delivery services to other residents in the community. This can reduce the impact of the access control on the delivery personnel, and can also take advantage of the same community, so that the user can collect the express package in time. The specific implementation steps are as follows: after the express package is delivered to the first terminal point, an address of a first user within a residential community is acquired; addresses of second users corresponding to all the express packages are acquired; the express packages of which the second users' addresses are within a preset distance from the first user are screened out and delivered by the first user.

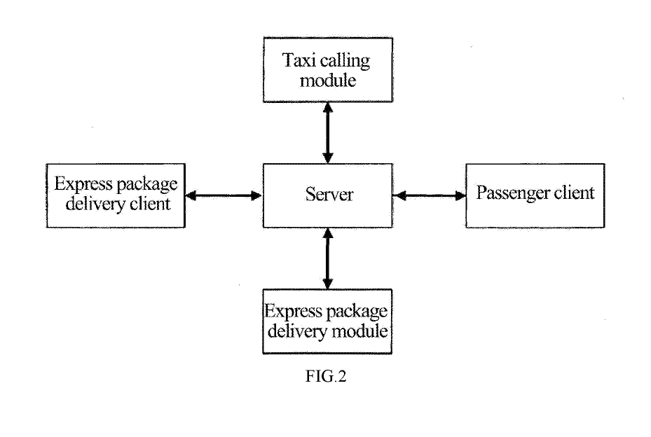

FIG. 2 is a schematic structural view of an embodiment of a taxi-based express package delivery system according to the present disclosure.

A taxi-based express package delivery system includes an express package delivery client, a server, and passenger clients. Each client is connected with the server through a network. The express package delivery client is configured to acquire a first start point and a first terminal point of the express package. The passenger clients are configured to acquire a second start point and a second terminal point of each of a plurality of taxis that carry passenger, and the server is configured to receive the first start point and the first terminal point of the express package delivery client and the second start point and the second terminal point of each of the passenger clients and generates a plurality of riding paths according to the second start points and the second terminal points. If the first start point is within a first preset distance of the riding path and the first terminal point is within a second preset distance of the riding path, the taxis that carry the eligible passenger are listed as delivery-capable taxis, and one of the delivery-capable taxis is notified to deliver the express package.

The express package delivery system further includes a taxi calling module connected with the server for acquiring an express package arrival time point. A time point when the delivery-capable taxi arrives at the first terminal point from the current position is calculated. And the taxi arrival time point is acquired. If the taxi arrival time point is later than the express package arrival time point, the corresponding delivery-capable taxi is removed from the delivery-capable taxis.

The taxi calling module acquires a latest delivery time of the express package according to the first start point, the first terminal point and the express package arrival time, and if there is no delivery-capable taxi available in a preset time range of the latest delivery time of the express package, a taxi is called according to the first start point and the first terminal point.

In real conditions, the situation of carpooling of express package and passenger is complicated. With the popularity of carpooling software, carpooling of express package and passenger becomes possible. Within the latest arrival time allowed by the express package, for example, if the express package start point is sent at 8 o'clock in the morning, and it is required to be delivered to the terminal point within 2 hours, and it takes only 30 minutes for the taxi to arrive at the terminal point from the start point, during this time, the taxi can pick up the passengers around, as long as the express package can be delivered on time. Therefore, through the start and terminal points of the express package delivery, the taxis carrying passengers around are sorted out at the beginning, so that the express package can be reached at the terminal point on time, and the passengers can get a discount for the ride through such carpooling.

The combination of express package and passenger needs to satisfy the requirements that the express package can be delivered on time and the passenger can arrive at the terminal point in time.

Therefore, a time point when the express package arrives is acquired. A time point is calculated when the delivery-capable taxi arrives at the first terminal point of the express package from the current position. The time point is acquired when the delivery-capable taxi arrives (i.e. the time point when the taxi arrives at the terminal point). If the time point when the delivery-capable taxi arrives at the first terminal point is later than the time point when the express package arrives at the first terminal point, the corresponding delivery-capable taxi is removed from the delivery-capable taxis. Through such a removing method, although the express package delivery can be guaranteed to arrive on time, and it directly leads to the possibility that no taxi meet the requirements. At this time, the fastest arrival time of the express package from the first start point to the first terminal point is roughly calculated, and then the latest departure time is obtained by the express package arrival time subtracting the fastest arrival time. When no carpooling of express package and passenger is formed when it is close to the latest departure time (such as 1-10 minutes in advance), a taxi is directly called according to the first start point and the first terminal point. The latest departure time of the express package is obtained through the first start point, the first terminal point and the express package arrival time. If there is no delivery-capable taxi in the preset time range of the latest departure time (generally 1-20 minutes in advance), a taxi is directly called according to the first start point and the first terminal point. The taxi that is called at this time is a non-carpooling taxi, and the cost is relatively higher.

In addition, the system further includes an express package delivery module, which is configured to acquire an address of a first user within a residential community after the express package is delivered to the first terminal point, to acquire addresses of second users corresponding to all the express packages, to screen out the express packages of which the second users' addresses are within a preset distance from the first user and to designate the first user to deliver the express packages.

The system embodiment and the method embodiment of the present disclosure are matched with each other, and the technical effects and benefits that can be achieved are consistent with the embodiments of the present disclosure and will not be repeatedly described herein.

As a preferred embodiment, the present disclosure further provides a taxi-based express package delivery server. The server is configured to acquire a first start point and a first terminal point of the express package, to acquire a second start point and a second terminal point of each of a plurality of passengers, and to generate a plurality of riding paths. If the first start point is within a first preset distance of the riding path and the first terminal point is within a second preset distance of the riding path, the taxi that carries the eligible passenger is listed as a delivery-capable taxi and the corresponding taxi is notified to deliver the express package.

Setting of the riding path, the start point and the terminal point as well as the preset distance are the same as those of the system of the present disclosure, and the implementation manner thereof is the same as that of the method embodiment of the present disclosure. Description thereof will not be repeated herein.

The above-described embodiments are merely illustrative of the implementations of the present disclosure, and the description thereof is not to be construed as to limit the scope of the invention. It should be noted that a plurality of variations and modifications may be made by those skilled in the art without departing from the spirit and scope of the invention. Therefore, the scope of the invention should be determined by the appended claims.

### INDUSTRIAL APPLICABILITY

By connecting the express package delivery client, the server, and the passenger client through the network, the present disclosure enables to screen the taxis carrying passengers around according to the start point, the terminal point and arrival time point of the express package at the very beginning. It guarantees that the express package can reach the terminal point on time, and at the same time, the passengers can get the discount of the ride through such a carpooling method. The present disclosure thus has industrial applicability.

What is claimed is:

1. A taxi-based express package delivery method, comprising the steps of:
acquiring a first start point and a first terminal point of an express package;
acquiring a second start point and a second terminal point of each of a plurality of taxis carrying passengers, and generating a plurality of riding paths;
listing a taxi as a delivery-capable taxi, if the first start point is within a first preset distance from the riding paths and the first terminal point is within a second preset distance from the riding paths;
acquiring a first time point when the express package arrives at the first terminal point; calculating a second time point when the delivery-capable taxi arrives at the first terminal point from a current position, and acquiring the second time point when the delivery-capable taxi arrives at the first terminal point; removing the corresponding delivery-capable taxi from the delivery-capable taxis if the second time point when the delivery-capable taxi arrives at the first terminal point is later than the first time point when the express package arrives at the first terminal point;
notifying the delivery-capable taxi to deliver the express package among the delivery-capable taxis, wherein the delivery-capable taxi has the second time point earlier than the first time point.

2. The taxi-based express package delivery method according to claim 1, characterized in that a latest departure time of the express package is acquired according to the first start point, the first terminal point and arrival time of the express package, and if there is no delivery-capable taxi available in the preset time range of the latest departure time, a taxi is called using the first start point and the first terminal point.

3. The taxi-based express package delivery method according to claim 1, characterized in that a third time point when the passenger requests to reach the second terminal point is acquired; a fourth time point when the delivery-capable taxi arrives at the second terminal point from the current position is calculated; the fourth time point when the delivery-capable taxi arrives at the second terminal point is acquired; if the fourth time point that the delivery-capable taxi arrives at the second terminal point is later than the fourth time point when the express package arrives at the second terminal point, the delivery-capable taxi is removed from the delivery-capable taxis.

4. The taxi-based express package delivery method according to claim 1, characterized in that after the express package is delivered to the first terminal point, an address of a first user within a residential community is acquired; addresses of second users corresponding to all express packages are acquired; the express packages of which the second users' addresses are within a preset distance from the first user are screened out and delivered by the first user.

5. The taxi-based express package delivery method according to claim 1, wherein a delivery path is acquired according to the first start point and the first terminal point; and a riding path is acquired according to the second start point and the second terminal point of the passenger; wherein the delivery path is consistent with the riding path.

6. A taxi-based express package delivery system, comprising: an express package delivery client, a server, and passenger clients; wherein the express package delivery client is configured to acquire a first start point and a first terminal point of the express package; the passenger clients are configured to acquire a second start point and a second terminal point of each of a plurality of taxis carrying passenger; the server is configured to receive the first start point, the first terminal point of the express package delivery client, the second start point and the second terminal point of each of the passenger clients and generates a plurality of riding paths according to the second start points and the second terminal points; if the first start point is within a first preset distance of the riding path and the first terminal point is within a second preset distance of the riding path, the taxi carrying the passenger is listed as a delivery-capable taxi; the express package delivery system further comprises a taxi calling module for acquiring a first time point when the express package arrives; a second time point when the delivery-capable taxi arrives at the first terminal point from the current position is calculated, and the second time point when the delivery-capable taxi arrives at the first terminal point is acquired; if the second time point of the delivery-capable taxi is later than the first time point of the express package, the corresponding delivery-capable taxi is removed from the delivery-capable taxis; and the delivery-capable taxi of which the second time point is earlier than the first time point is notified to deliver the express package among the delivery-capable taxis.

7. The taxi-based express package delivery system according to claim 6, characterized in that the taxi calling module acquires a latest delivery time of the express package according to the first start point, the first terminal point and the express package arrival time; if there is no delivery-capable taxi available in a preset time range of the latest delivery time of the express package, a taxi is called according to the first start point and the first terminal point.

8. The taxi-based express package delivery system according to claim 6, characterized in that the system further comprises an express package delivery module; wherein the express package delivery module is configured to acquire an address of a first user within a residential community after the express package is delivered to the first terminal point, to acquire addresses of second users corresponding to all the express packages, and to screen out the express packages of which the second users' addresses are within a preset distance from the first user and designate them to the first user for delivery.

9. A taxi-based express package delivery server, characterized in that the server is connected to a taxi calling module; the server is configured to acquire a first start point and a first terminal point of the express package, to acquire a second start point and a second terminal point of each of a plurality of taxis that carry passengers and to generate a plurality of riding paths; if the first start point is within a first preset distance from the riding paths and the first terminal point is within a second preset distance from the riding paths, the taxi is listed as a delivery-capable taxi; the taxi calling module is configured to acquire a first time point when the express package arrives at a first terminal point, to calculate a second time point when the delivery-capable taxi arrives at the first terminal point from the current position, and to acquire the second time point when the delivery-capable taxi arrives at the first terminal point; if the second time point when the delivery-capable taxi arrives at the first terminal point is later than the first time point when the express package arrives at the first terminal point, the corresponding delivery-capable taxi from the delivery-capable taxis is removed; the delivery-capable taxi is notified of which the second time point is earlier than the first time point to deliver the express package.
